(19) United States
(12) Patent Application Publication
(10) Pub. No.: US 2024/0343542 A1
(43) Pub. Date: Oct. 17, 2024

(54) MOBILE TERMINAL AND REMOTE SUPPORT SYSTEM

(71) Applicant: TOYOTA JIDOSHA KABUSHIKI KAISHA, Toyota-shi (JP)

(72) Inventors: Kosuke AKATSUKA, Mishima-shi (JP); Rio SUDA, Toyota-shi (JP); Yuki SUEHIRO, susono-shi (JP)

(73) Assignee: TOYOTA JIDOSHA KABUSHIKI KAISHA, Toyota-shi (JP)

(21) Appl. No.: 18/617,822

(22) Filed: Mar. 27, 2024

(30) Foreign Application Priority Data
Apr. 11, 2023 (JP) 2023-064162

(51) Int. Cl. B66F 9/075; G05D 1/223; G05D 105/20; G05D 107/70; G05D 111/30; G05D 111/50

(52) U.S. Cl. CPC B66F 9/07581; G05D 1/2232; G05D 2105/20; G05D 2107/70; G05D 2111/30; G05D 2111/50

(57) ABSTRACT

A mobile terminal is operated by an operator to remotely support a moving body, and includes a communication device, a touch panel, and a processor. A motion of the moving body is controlled in accordance with an operation of the operator tilting the mobile terminal while touching the touch panel. The processor is configured to: determine, as a reference angle in a specific rotation direction of the mobile terminal, a tilt angle in the specific rotation direction at a time point of detection of a touch by the operator on the touch panel; generate a control signal for the motion based on the reference angle and the tilt angle in the specific rotation direction during a control validity period in which the touch is continued from the time point of the detection; and transmit the generated control signal to the moving body via the communication device.

### CROSS-REFERENCE TO RELATED APPLICATION

The present disclosure claims priority under 35 U.S.C. § 119 to Japanese Patent Application No. 2023-064162, filed on Apr. 11, 2023, which is incorporated herein by reference in its entirety.

### BACKGROUND

### Technical Field

The present disclosure relates to a technique for remotely supporting a moving body using a mobile terminal.

### Background Art

JP 2019-077528 A discloses a remote operation system for remotely operating a forklift using a remote operation device, such as a smartphone. This remote operation includes tilting the remote operation device to control the steering of the forklift. As a reference position (reference angle) of the tilt angle of the remote operation device for the steering, a tilt angle obtained when the longitudinal direction of the remote operation device coincides with the horizontal direction thereof is used.

### SUMMARY

With regard to remote driving of a moving body using an operation of tilting a mobile terminal, such as the remote operation device described in JP 2019-077528 A, a movable range of a wrist of an operator of the mobile terminal and a holding posture of the mobile terminal vary from person to person. Further, the operator cannot know the absolute angle of the mobile terminal held by the operator. Therefore, it may be difficult for the operator to know how to tilt the mobile terminal to start the operation of the moving body.

The present disclosure has been made in view of the problem described above, and an object of the present disclosure is to provide a technique that can improve the operability of remote driving of a moving body using an operation of tilting a mobile terminal.

A mobile terminal according to the present disclosure is operated by an operator to remotely support a moving body, and includes a communication device, a touch panel, and a processor. The communication device is configured to perform wireless communication with the moving body. The touch panel is configured to detect a presence or absence of a touch by the operator. A motion of the moving body is controlled in accordance with an operation of the operator tilting the mobile terminal while touching the touch panel. The processor is configured to: determine, as a reference angle in a specific rotation direction of the mobile terminal, a tilt angle of the mobile terminal in the specific rotation direction at a time point of detection of a touch by the operator on the touch panel; generate a control signal for the motion of the moving body based on the reference angle and the tilt angle in the specific rotation direction during a control validity period in which the touch is continued from the time point of the detection; and transmit the generated control signal to the moving body via the communication device.

A remote support system according to the present disclosure includes a moving body and a mobile terminal operated by an operator to remotely support the moving body. The mobile terminal includes: a communication device configured to perform wireless communication with the moving body; and a touch panel configured to detect a presence or absence of a touch by the operator. A motion of the moving body is controlled in accordance with an operation of the operator tilting the mobile terminal while touching the touch panel. The remote support system includes one or more processors configured to: determine, as a reference angle in a specific rotation direction of the mobile terminal, a tilt angle of the mobile terminal in the specific rotation direction at a time point of detection of a touch by the operator on the touch panel; and generate a control signal for the motion of the moving body based on the reference angle and the tilt angle in the specific rotation direction during a control validity period in which the touch is continued from the time point of the detection.

According to the present disclosure, the operator can easily recognize the reference angle. Therefore, the operability of remote driving of the moving body using the operation of tilting the mobile terminal can be improved.

### BRIEF DESCRIPTION OF THE DRAWINGS

FIG. 1 is a schematic diagram illustrating a configuration example of a remote support system according to an embodiment;

FIG. 2 is a time chart used to describe a method of determining a tilt angle used for calculating a target vehicle speed in vehicle speed control according to an embodiment;

FIG. 3A shows a method of calculating the target vehicle speed based on the tilt angle;

FIG. 3B shows a method of calculating the target vehicle speed based on the tilt angle;

FIG. 4 is a flowchart illustrating an example of processing related to the vehicle speed control according to an embodiment;

FIG. 5A shows a method of calculating a target value of a control amount based on the tilt angle;

FIG. 5B shows a method of calculating a target value of a control amount based on the tilt angle;

FIG. 5C shows a method of calculating a target value of a control amount based on the tilt angle; and

FIG. 6 is a flowchart illustrating an example of processing related to vehicle motion control according to an embodiment.

### DETAILED DESCRIPTION

Embodiments of the present disclosure will be described with reference to the accompanying drawings.

### 1. Remote Support System

With regard to “remote support of a moving body”, the remote support is a concept that includes remote monitoring, remote assistance, and remote driving. Examples of the moving body include a vehicle and a robot. The vehicle may be an automated driving vehicle, or a vehicle driven by a driver. Examples of the robot include a logistics robot. As an example, in the following description, the moving body that is a target of the remote support is a vehicle. When generalizing, “vehicle” in the following description shall be deemed to be replaced with “moving body”.

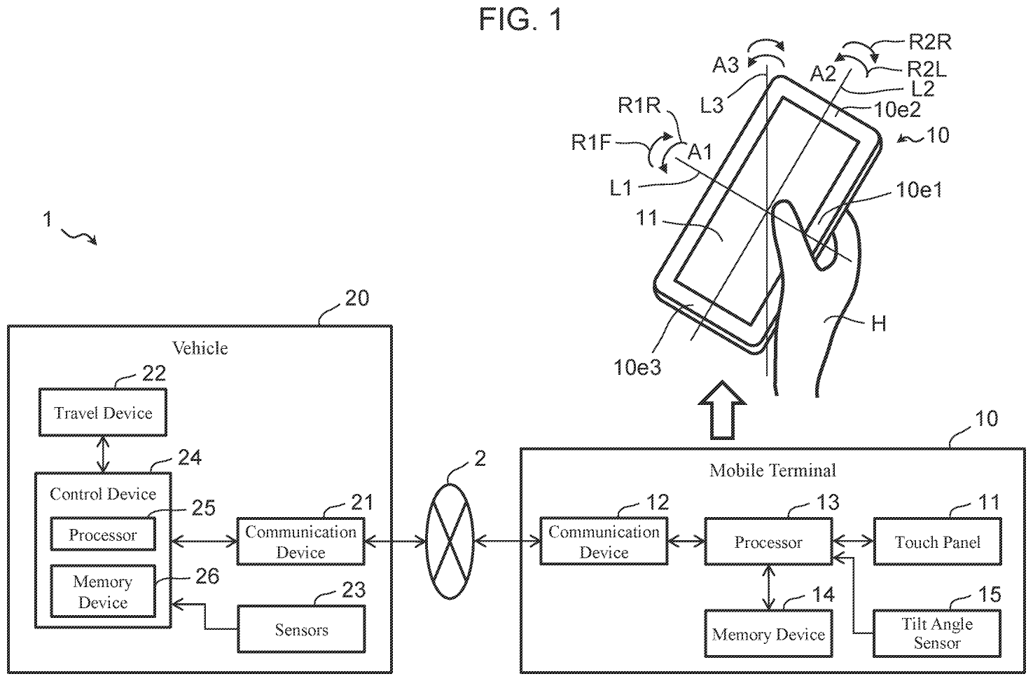

FIG. 1 is a schematic diagram illustrating a configuration example of a remote support system 1 according to an embodiment. The remote support system 1 includes a mobile terminal (i.e., a mobile device) 10 and a vehicle 20, and is configured to perform remote driving of the vehicle 20 using the mobile terminal 10. It should be noted that the remote support system 1 may be configured to perform at least one of remote assistance and remote monitoring of the vehicle 20 using the mobile terminal 10, in addition to the remote driving.

The mobile terminal (or simply referred to as the terminal) 10 is operated by an operator for the remote driving (remote operation) of the vehicle 20. The terminal 10 includes a touch panel 11, a communication device 12, a processor 13, a memory device 14, and a tilt angle sensor 15. For example, the terminal 10 is formed in a rectangular plate shape in which one side is a longitudinal direction and the other side is a short direction as shown in FIG. 1. The terminal 10 is, for example, a smartphone or a tablet terminal.

The touch panel 11 is formed on one plate surface of the terminal 10. For example, the touch panel 11 has a rectangular shape having a longitudinal direction and a short direction, and the longitudinal direction of the touch panel 11 coincides with the longitudinal direction of the terminal 10. The touch panel 11 is configured to display any images. Also, the touch panel 11 includes a touch sensor. The touch sensor is configured to detect whether or not the operator is touching the touch panel 11.

The communication device 12 is configured to communicate with the vehicle 20 via a wireless communication network 2. The processor 13 is configured to execute various processes for the remote driving of the vehicle 20. The memory device 14 is configured to store various types of information necessary for the processes by the processor 13. More specifically, the processor 13 executes various processes using various programs related to the remote driving. The various programs may be stored in the memory device 14 or may be recorded in a computer-readable recording medium.

The tilt angle sensor 15 is configured to detect a tilt angle (i.e., posture) of the terminal 10. The tilt angle sensor 15 includes, for example, a three-axis gyro sensor. More specifically, the tilt angle sensor 15 detects, as a tilt angle A1, a rotation angle of the terminal 10 around a rotation axis parallel to a center line L1. The center line L1 passes through the center of the terminal 10 and extends in the short direction of the terminal 10. Similarly, the tilt angle sensor 15 detects, as a tilt angle A2, a rotation angle around a rotation axis parallel to a center line L2, and detects, as a tilt angle A3, a rotation angle around a rotation axis parallel to a center line L3. The center line L2 passes through the center of the terminal 10 and extends in the longitudinal direction of the terminal 10. The center line L3 passes through the center of the terminal 10 and extends in a thickness direction of the terminal 10. Further, the center lines L1, L2, and L3 are orthogonal to each other.

The vehicle 20 includes a communication device 21, a travel device 22, sensors 23, and a control device 24. The communication device 21 communicates with the outside of the vehicle 20. For example, the communication device 21 communicates with the mobile terminal 10. The travel device 22 includes a steering device, a drive device, and a brake device. The steering device includes an electric motor configured to steer wheels of the vehicle 20. The drive device includes one or both of an electric motor and an internal combustion engine for driving the vehicle 20. The brake device includes a brake actuator for braking the vehicle 20.

The sensors 23 include a recognition sensor, a vehicle state sensor, a position sensor, and a shift position sensor. The recognition sensor recognizes a situation around the vehicle 20. Examples of the recognition sensor include a camera, a laser imaging detection and ranging (LIDAR), and a radar. The vehicle state sensor detects a state of the vehicle 20. The vehicle state sensor includes a speed sensor, an acceleration sensor, a yaw rate sensor, and a steering angle sensor, for example. The position sensor detects a position and orientation of the vehicle 20. For example, the position sensor includes a global navigation satellite system (GNSS) receiver. The shift position sensor detects a shift range of the vehicle 20.

The control device 24 is a computer configured to control the vehicle 20. The control device 24 includes one or more processors 25 (hereinafter, simply referred to as a processor 25) and one or more memory devices 26 (hereinafter, simply referred to as a memory device 26). The processor 25 executes various processes related to control of the vehicle 20. The memory device 26 stores various types of information necessary for the processes by the processor 25.

### 2. Vehicle Motion Control Using Mobile Terminal

The terminal 10 is used to control the motion of the vehicle 20 (vehicle motion). Basically, the operator operates the terminal 10 from outside the vehicle 20 to remotely control the vehicle motion. However, the vehicle motion control using the terminal 10 may be performed when the operator is in the vehicle 20.

In the remote support system 1, the motion of the vehicle 20 is controlled in accordance with the operation of the operator tilting the terminal 10 while touching the touch panel 11. That is, from the viewpoint of fail-safe, in the system 1, the vehicle motion control using the terminal 10 is only valid while the operator is touching the touch panel 11.

### 2-1. Vehicle Speed Control

Hereinafter, speed control of the vehicle 20 (vehicle speed control) will be described as an example of the vehicle motion control using the terminal 10. The vehicle speed control is an example of control of the longitudinal-direction motion (i.e., forward movement and backward movement) of the vehicle 20. The vehicle speed control includes driving control and braking control of the vehicle 20.

The operation of tilting the terminal 10 for the vehicle speed control is performed, for example, as follows. Here, examples EX1 and EX2 will be described in order as examples of how the operator holds the terminal 10. In the example EX1, as illustrated in FIG. 1, the operator holds one end 10e1 of the terminal 10 in the short direction with one hand H. In the example EX1, an operation in which the operator tilts the terminal 10 so as to rotate around the center line L1 is used. More specifically, for example, the forward motion of the vehicle 20 is performed in response to an operation of the operator rotating the terminal 10 such that an end 10e2 of the terminal 10 on the side far from the operator is lowered (that is, in a rotation direction R1F). Then, as described below, the backward motion of the vehicle 20 is performed in response to an operation of the operator rotating the terminal 10 such that the end 10e2 is raised (i.e., in a rotation direction R1R). On the other hand, in the example EX2 (not illustrated), the operator holds each of the end 10e2 and another end 10e3 in the longitudinal direction of the terminal 10 with his or her hands. In the example EX2, an operation in which the operator tilts the terminal 10 so as to rotate around the center line L2 is used for the vehicle speed control.

In the present embodiment, in order to improve the operability of the remote driving of the vehicle 20 using the operation of tilting the terminal 10, the processor 13 executes the following processing.

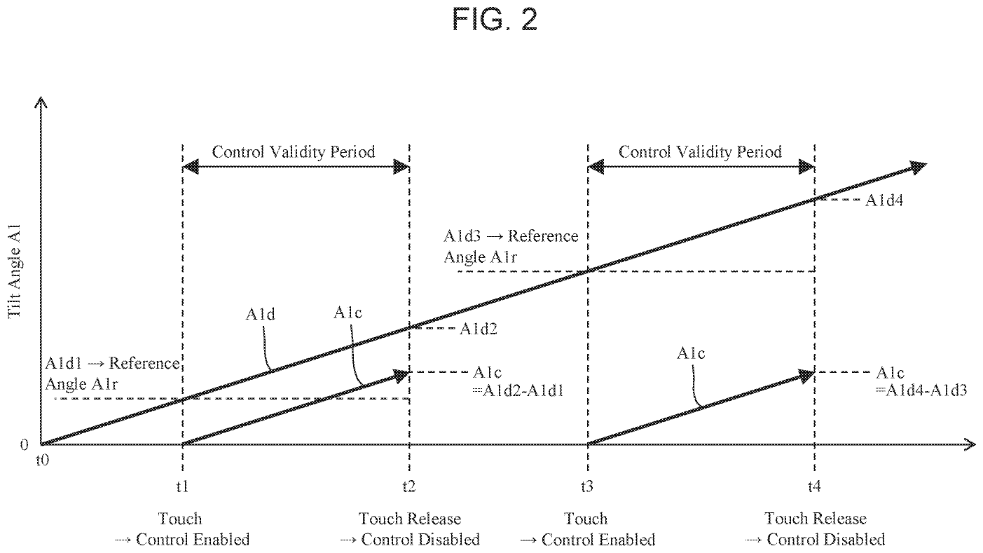

FIG. 2 is a time chart used to describe a method of determining a tilt angle A1c used for calculating a target vehicle speed Vt in the vehicle speed control according to the embodiment. FIG. 2 is described together with the example EX1 of how to hold the terminal 10. A tilt angle A1 in FIG. 2 corresponds to a tilt angle of the terminal 10 used for the vehicle speed control, that is, a rotation angle of the terminal 10 around the rotation direction R1F. That is, FIG. 2 shows the tilt angle A1 obtained when the operator tilts the terminal 10 to move the vehicle 20 forward. Although not illustrated, the tilt angle A1 in the backward movement is the same as that in the forward movement except that the sign thereof is negative.

The value of the tilt angle A1 detected by the tilt angle sensor 15 is referred to as “tilt angle A1d”. In FIG. 2, the tilt angle A1d detected when the surface of the touch panel 11 is horizontal (that is, when the plane including the center lines L1 and L2 is horizontal) is set to 0 as an example. However, the 0 point of the tilt angle A1d may be set freely. In addition, in the example EX2, the tilt angle A1d detected when the plane including the center lines L1 and L3 is horizontal may be, for example, set to 0.

At a time point t0 in FIG. 2, the touch panel 11 is horizontal (i.e., the tilt angle A1d=0). In order to simplify the description, FIG. 2 illustrates an example in which, in response to the operation by the operator, the tilt angle A1d monotonically increases as time elapses from the time point t0. A time point t1 corresponds to a time point at which a touch of the hand H of the operator on the touch panel 11 is detected. Then, a subsequent time point t2 corresponds to a time point when the touch of the hand H is released. As described above, the vehicle speed control is valid only while the hand H is touching the touch panel 11. Therefore, the vehicle speed control becomes valid at the time point t1 and becomes invalid at the time point t2. That is, a period from the time point t1 to the time point t2 corresponds to a “control validity period”. Similarly, a period from a time point t3 to a time point t4 thereafter also corresponds to the control validity period.

In the vehicle speed control according to the present embodiment, the tilt angle A1d at the detection time point of the touch (i.e., a tilt angle in the rotation direction R1F corresponding to the “specific rotation direction”) is determined as a reference angle A1r. Then, a difference (=A1d−A1r) between the tilt angle A1d and the reference angle A1r during the control validity period in which the touch on the touch panel 11 is continued is determined as a “tilt angle A1c” used for calculating the target vehicle speed Vt. That is, the tilt angle A1c corresponds to a relative angle of the tilt angle A1d with respect to the reference angle A1r during the control validity period.

For example, in the control validity period from the time point t1 to the time point t2, a tilt angle A1d1 at the time point t1 is used as the reference angle A1r for this the control validity period. Therefore, as shown in FIG. 2, the tilt angle A1c in the control validity period becomes 0 at the time point t1. Then, at the time point t2, the tilt angle A1c becomes equal to the difference between a tilt angle A1d2 at the time point t2 and the tilt angle A1d1. Similarly, in the control validity period from the time point t3 to the time point t4, a tilt angle A1d3 at the time point t3 is used as the reference angle A1r for this control validity period. In addition, the tilt angle A1c in the control validity period becomes 0 at the time point t3, and becomes equal to the difference (=A1d4−A1d3) at the time point t4.

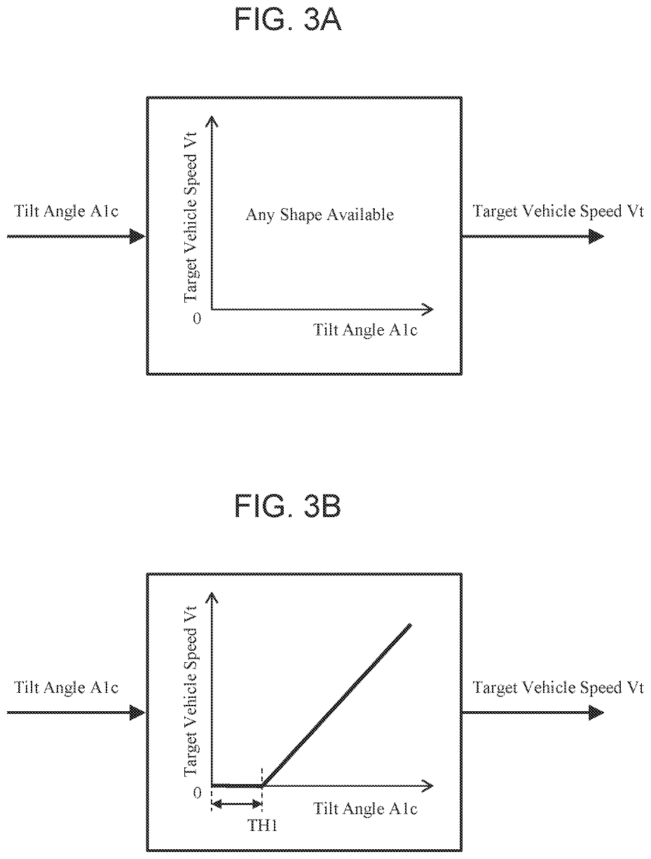

FIGS. 3A and 3B each show a method of calculating the target vehicle speed Vt based on the tilt angle A1c. As shown in FIG. 3A, the processor 13 calculates the target vehicle speed Vt based on the tilt angle A1d during the control validity period and the reference angle A1r (i.e., based on the tilt angle A1c). To be specific, as shown in FIG. 3A, the processor 13 calculates the target vehicle speed Vt according to the tilt angle A1c from relation information (for example, a map or a relational equation) that defines a relation between the tilt angle A1c and the target vehicle speed Vt. Basically, the relation information is determined such that the target vehicle speed Vt becomes higher when the tilt angle A1c is greater. However, the specific relation between the tilt angle A1c and the target vehicle speed Vt (i.e., the specific shape of the relation when represented in the graph) may be determined freely.

FIG. 3B shows an example of a specific method of determining the relation between the tilt angle A1c and the target vehicle speed Vt. In this example, when the tilt angle A1c is between 0 and a designated threshold value TH1, the target vehicle speed Vt is constant at 0. Also, when the tilt angle A1c becomes equal to or greater than the threshold value TH1, the target vehicle speed Vt increases linearly in association with an increase in the tilt angle A1c, for example. As in this example, a dead zone may be provided such that the target vehicle speed Vt (i.e., a target value of a control amount of the vehicle motion) does not change in accordance with the tilt angle A1c (i.e., the difference between the tilt angle A1d during the control validity period and the reference angle A1r) when the tilt angle A1c is less than the threshold value TH1.

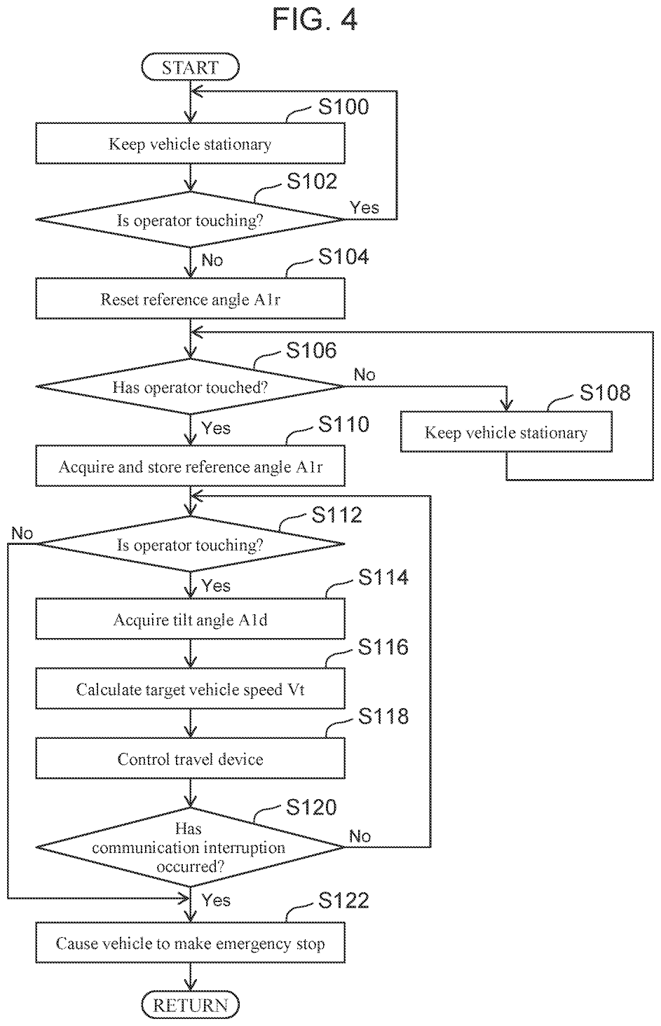

FIG. 4 is a flowchart illustrating an example of processing related to the vehicle speed control according to the embodiment. For example, the processing of this flowchart is executed in cooperation between the processor 13 of the terminal 10 and the processor 25 of the vehicle 20. This processing is started, for example, in response to a request to start the vehicle speed control from the operator who operates the terminal 10. In addition, it is assumed that the operator knows in advance that the tilt angle A1d at the time of the touch on the touch panel 11 becomes the reference angle A1r. Further, it is assumed that the operator knows in advance that the vehicle speed control can be started or resumed by touching the touch panel 11 after once releasing the touch from a state in which the touch panel 11 is touched.

In step S100, the processor 25 keeps the vehicle 20 stationary. When the stop of the vehicle 20 is kept as described above, the processor 13 determines whether or not the operator is touching the touch panel 11 (step S102). As a result, when the touch is detected (step S102; Yes), the stop of the vehicle 20 is kept. On the other hand, when the touch is not detected (step S102; No), the processor 13 resets the reference angle A1r to an initial value (for example, 0) (step S104).

After the reference angle A1r is reset in step S104, the processor 13 determines whether or not the operator has touched the touch panel 11 (step S106). As a result, while the touch is not detected (step S106; No), the stop of the vehicle 20 is kept (step S108). On the other hand, when the touch is detected (step S106; Yes), the processing proceeds to step S110.

In step S110, the processor 13 detects the tilt angle A1d using the tilt angle sensor 15, and acquires the detected tilt angle A1d as the reference angle A1r. Then, the processor 13 stores the acquired reference angle A1r in the memory device 14. Thereafter, the processing proceeds to step S112.

In step S112, the processor 13 determines whether or not the touch detected in step S106 is continued. As a result, when the touch is released, that is, when the touch is not continued (step S112; No), the processing proceeds to step S122.

On the other hand, when the touch is continued (step S112; Yes), the processor 13 detects (acquires) the tilt angle A1d using the tilt angle sensor 15 (step S114). Thereafter, the processing proceeds to step S116.

In step S116, the processor 13 calculates, as the tilt angle A1c, a difference between the tilt angle A1d acquired in step S114 and the reference angle A1r acquired in step S110. Then, the processor 13 calculates a target vehicle speed Vt according to the calculated tilt angle A1c by using the relation information shown in FIG. 3B, for example. Thereafter, the processing proceeds to step S118. In addition, in the example of the processing illustrated in FIG. 4, the calculated target vehicle speed Vt (that is, a control signal) is transmitted from the terminal 10 to the vehicle 20 via the communication device 12.

In step S118, the processor 25 of the vehicle 20 controls the travel device 22 such that the target vehicle speed Vt calculated in step S116 is obtained. In addition, when the terminal 10 is tilted such that the tilt angle A1c becomes 0 (i.e., such that the tilt angle A1d coincides with the reference angle A1r) while the vehicle 20 is traveling, the vehicle 20 stops.

In step S120 subsequent to step S118, the processor 25 determines whether or not a communication interruption has occurred between the vehicle 20 and the terminal 10. As a result, when the communication interruption does not occur (step S120; No), the processing returns to step S112.

On the other hand, when the communication interruption has occurred (step S120; Yes), the processor 25 causes the vehicle 20 to make an emergency stop (step S122). As described above, according to the processing shown in FIG. 4, when a communication interruption occurs, the vehicle 20 is automatically stopped.

As described above, according to the present embodiment, the tilt angle A1d of the terminal 10 at the time point of detection of a touch on the touch panel 11 by the operator is determined as the reference angle A1r. Then, a control signal for the vehicle 20 based on the reference angle A1r and the tilt angle A1d during the control validity period in which the touch is continued from the detection time point is generated. That is, the target vehicle speed Vt based on the tilt angle A1c is generated. As described above, according to the present embodiment, the reference point of the tilt angle A1d (that is, the reference angle A1r) can be set freely by the operator. Therefore, when the motion of the vehicle 20 is controlled using the operation of tilting the terminal 10, the operator can easily recognize the reference angle A1r. More specifically, the operator can easily recognize the operation start point of the vehicle motion. As a result, the operability of the remote driving of the vehicle 20 using the operation of tilting the terminal 10 can be improved.

Moreover, according to the present embodiment, the reference angle A1r is reset in response to release of the touch on the touch panel 11 by the operator. Thus, the reference angle A1r can be reset while the operator is not touching the touch panel 11.

Moreover, according to the present embodiment, when a new touch on the touch panel 11 is detected after the touch by the operator is released, the reference angle A1r is updated by the tilt angle A1d at the time of detection of the new touch. This makes it possible to appropriately update the reference angle A1r by using the touch on the touch panel 11 and the release of the touch by the operator.

Furthermore, as in the example shown in FIG. 3B, the range of the tilt angle A1c in which the tilt angle A1c is less than the threshold value TH1 may be treated as a dead zone with respect to the setting of the target vehicle speed Vt. As a result, it is possible to prevent the vehicle 20 from suddenly moving in association with the operation of tilting the terminal 10.

Additionally, according to the processing illustrated in FIG. 4, where the communication interruption described above is resolved after the occurrence of the communication interruption, even if the operator continues the touch from before the emergency stop of the vehicle 20, the stopped state of the vehicle 20 is kept until the operator once releases the touch on the touch panel 11 (steps S100 and S102). Then, when the touch is released, the reference angle A1r is reset (step S104). The reason why the system 1 is configured as described above is as follows. That is, according to the processing of step S122, when the communication is interrupted, the vehicle 20 decelerates and stops regardless of the operation amount (i.e., the tilt angle A1c) of the operator. Therefore, the operator loses the relation of the target vehicle speed Vt with respect to the tilt angle A1c in association with the emergency stop. As a result, if the processing proceeds to step S112 without going through steps S100 to S110 at the time of recovery from the communication interruption, there is a possibility that a sudden vehicle behavior may occur. Therefore, according to the processing shown in FIG. 4, in order to ensure the opportunity for the operator to relearn the reference angle A1r, the stopped state of the vehicle 20 is kept until the operator once releases the touch on the touch panel 11.

### 2-2. Vehicle Acceleration Control

As vehicle longitudinal direction control included in the vehicle motion control using the terminal 10, the following vehicle acceleration control may be executed instead of or in addition to the vehicle speed control described above. To be specific, the tilt angle A1c described above may be used for the vehicle acceleration control.

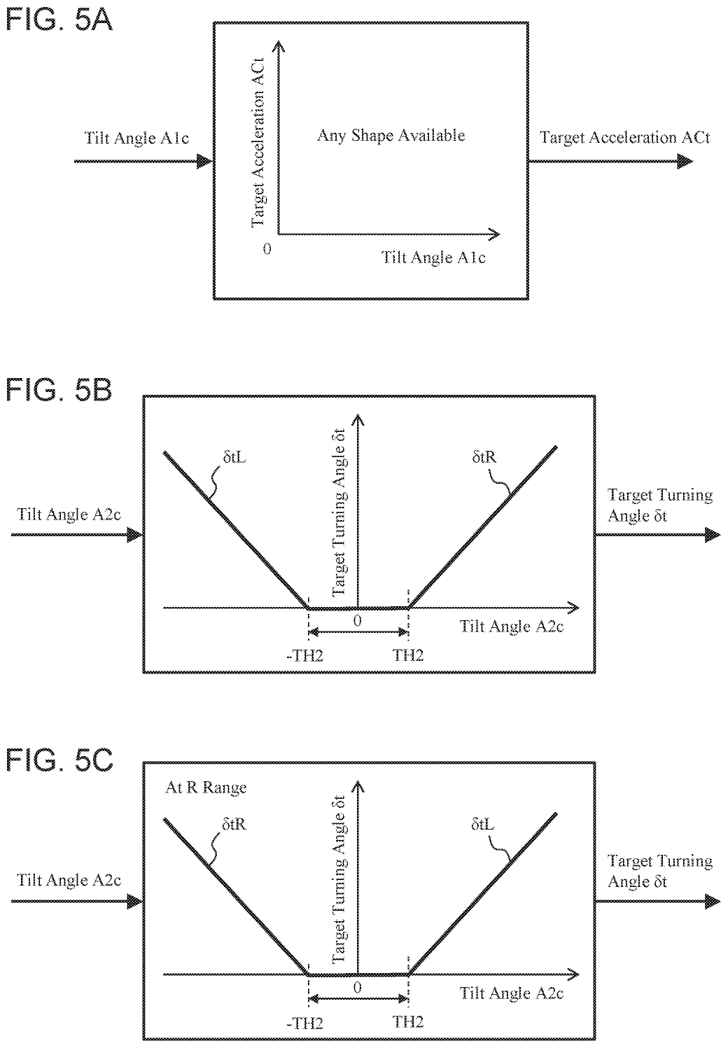

FIG. 5A shows a method of calculating a target acceleration ACt based on the tilt angle A1c. As shown in FIG. 5A, the processor 13 calculates a target acceleration ACt based on the tilt angle A1d during the control validity period and the reference angle A1r (i.e., based on the tilt angle A1c). Basically, the relation information that defines a relation between the tilt angle A1c and the target acceleration ACt is determined such that the target acceleration ACt becomes higher when the tilt angle A1c is greater. However, the specific method of determining the relation between the tilt angle A1c and the target acceleration ACt is not particularly limited, and the relation may be determined freely. In addition, similarly to the example shown in FIG. 3B, a dead zone may be provided such that the target acceleration ACt does not change in accordance with the tilt angle A1c when the tilt angle A1c is less than a predetermined threshold value.

### 2-3. Vehicle Lateral Direction Control

Moreover, as the vehicle motion control, instead of or in addition to the vehicle longitudinal direction control, the following vehicle lateral direction control may be performed.

In the example EX1 of how to hold the terminal 10, an operation in which the operator tilts the terminal 10 such that the terminal 10 rotates around a rotation axis parallel to the center line L2 is used for the vehicle lateral direction control. That is, the tilt angle A2 (see FIG. 1) is used. More specifically, for example, a right turning motion (i.e., a right steering motion) of the vehicle 20 is performed in response to an operation of the operator rotating the terminal 10 around a rotation direction R2R. Further, a left turning motion (i.e., a left steering motion) of the vehicle 20 is performed in response to an operation of the operator rotating the terminal 10 around a rotation direction R2L. In addition, in the example EX2, an operation in which the operator tilts the terminal 10 so as to rotate around the center line L3 (see FIG. 1) is used. That is, the tilt angle A3 (see FIG. 1) is used.

The basic configuration of the vehicle lateral direction control is similar to the basic configuration of the vehicle longitudinal direction control shown in FIG. 2. That is, also in the vehicle lateral direction control, a tilt angle A2d detected by the tilt angle sensor 15 at the detection time point of the touch is determined as a reference angle A2r. Further, a difference between the tilt angle A2d during the control validity period and the reference angle A2r (=A2d−A2r) is determined as a tilt angle A2c used to calculate a target value of a control amount of the turning motion. The target value is, for example, a target turning angle δt that is a target value of a turning angle of wheels of the vehicle 20. Alternatively, the target value may be, for example, a target yaw rate or a target lateral acceleration.

FIG. 5B shows a method of calculating the target turning angle δt based on the tilt angle A2c. It is assumed herein that the tilt angle A2c is positive when the vehicle 20 turns right. As shown in FIG. 5B, basically, the relation information that defines a relation between the tilt angle A2c and the target turning angle δt is determined such that the target turning angle &t (more specifically, each of a target turning angle δtR at the time of right turn and a target turning angle δtL at the time of left turn) becomes greater when the absolute value of the tilt angle A2c is greater. However, the specific method of determining the relation between the tilt angle A2c and the target turning angle δt is not particularly limited, and the relation may be determined freely.

Furthermore, in the example shown in FIG. 5B, a range in which the absolute value of the tilt angle A2c is less than a threshold value TH2 is treated as a dead zone. By providing the dead zone, the straight traveling state of the vehicle 20 can be easily created. However, the dead zone may not necessarily be provided.

Additionally, when the control of the turning motion using the operation of tilting the terminal 10 is performed together with the vehicle longitudinal direction control described above, the above-described method of the vehicle lateral direction control may not be applied in order to determine the reference angle A2r used for the control of the turning motion. That is, the reference angle A2r may be the tilt angle A2d obtained when the terminal 10 is in the horizontal state, instead of the tilt angle A2d obtained at the time point of detection of the touch. For example, in the example EX1, the tilt angle A2d obtained when the center line L1 is horizontal may be used as the reference angle A2r.

2-4. Vehicle Motion Control when Reversing

First, a first control example when reversing the vehicle 20 will be described. In the first control example, when the vehicle 20 is moved backward, a tilt angle (that is, a negative tilt angle A1c) obtained by tilting the terminal 10 in a direction opposite to the direction in which the vehicle 20 is moved forward with reference to the reference angle A1r is used. For example, the rotation direction R1R with respect to the rotation direction R1F in FIG. 1 is used. More specifically, the target vehicle speed Vt at the time of reversing is basically determined so as to become higher when the tilt angle A1c is greater on the negative side.

Further, in the first control example, the vehicle lateral direction control at the time of reversing is performed as follows. That is, the vehicle lateral direction control is performed such that, when the terminal 10 is tilted in the same direction, the target turning angle δtR or δtL in the same direction is calculated regardless of whether the vehicle 20 is moving forward or moving backward.

Next, a second control example when reversing the vehicle 20 will be described. In the second control example, the target value of the control amount of the motion of the vehicle 20 in the longitudinal direction (for example, the target vehicle speed Vt) is treated as follows in accordance with the shift range of the vehicle 20. That is, when a D (drive) range for the forward movement is selected, the target vehicle speed Vt according to the tilt angle A1c is determined using the same relation (i.e., the same relation information) as that in the first control example described above. On the other hand, when an R (reverse) range for the backward movement is selected, a relation (i.e., relation information) obtained by inverting, about the target vehicle speed axis at the position of the 0 point of the tilt angle A1c (that is, at the position of the reference angle A1r), the relation used when the D range is selected is used for backward motion. That is, when the R range is selected, the target vehicle speed Vt for the forward motion based on the tilt angle A1c in the rotation direction R1F when the D range is selected is directly read as the target vehicle speed Vt for the backward motion.

Further, in the second control example, the target value of the control amount of the motion in the turning direction of the vehicle 20 (for example, the target turning angle St) is treated as follows in accordance with the shift range of the vehicle 20. FIG. 5C shows a method of calculating the target turning angle δt based on the tilt angle A2c at the time of reversing. When the D range is selected, the relation shown in FIG. 5B is used for the turning motion at the time of the forward movement. Further, when the R range is selected, as shown in FIG. 5C, a relation (i.e., relation information) obtained by inverting the relation shown in FIG. 5B about the target turning angle axis at the position of the 0 point of the tilt angle A2c (i.e., the reference angle A2r) is used for the turning motion at the time of the backward movement.

According to the second control example described above, when the R range is selected, the operator outside or inside the vehicle 20 can operate the terminal 10 in the same manner as when the vehicle 20 moves forward while facing the backward direction of the vehicle 20.

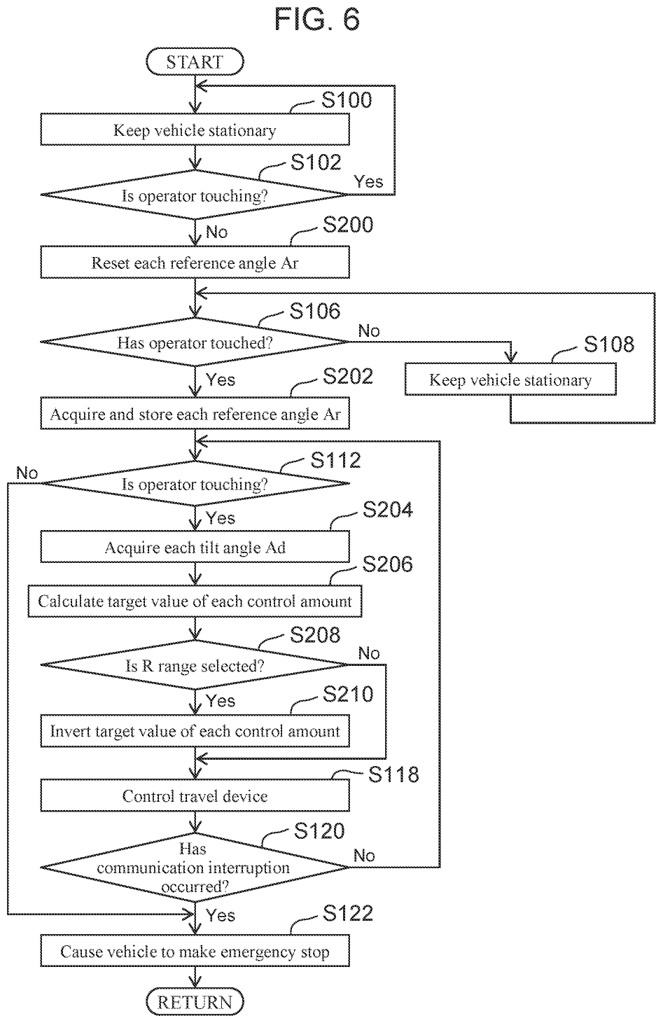

FIG. 6 is a flowchart illustrating an example of processing related to the vehicle motion control according to the embodiment. The processing of this flowchart is different from the flowchart shown in FIG. 4 in that processing related to the second control example depending on the shift range is included.

To be specific, in FIG. 6, a touch is not detected in step S102, the processor 13 resets one or more reference angles Ar (for example, the reference angles A1r and A2r) (step S200).

Further, when a touch is detected in step S106, the processor 13 acquires one or more new reference angles Ar (for example, the reference angles A1r and A2r) and stores the one or more new reference angles Ar in the memory device 14 (step S202). Thereafter, when the touch is continued (step S112; Yes), the processor 13 acquires one or more tilt angles Ad (for example, the tilt angles A1d and A2d) using the tilt angle sensor 15 (step S204). Then, the processor 13 calculates one or more target values (for example, the target vehicle speed Vt and the target turning angle δt) of one or more respective control amounts according to the one or more tilt angles Ad and the one or more reference angles Ar (step S206).

In step S208 following step S206, the processor 13 determines whether or not the R range is selected based on shift range information received from the vehicle 20. Two shift ranges, i.e., the D range and the R range, are assumed to be selected during execution of the vehicle motion control according to the present embodiment. When this determination result is No, that is, when the D range is selected, the processing proceeds to step S118.

On the other hand, when the R range is selected (step S208; Yes), the processor 13 acquires the target value of each control amount used when the R range is selected by inverting the target value of each control amount used when the D range is selected as in the second control example described above (step S210). Thereafter, the processing proceeds to step S118.

### 2-5. Other Examples Regarding Division of Processing

In the examples of the processing illustrated in FIGS. 4 and 6 described above, the processor 13 of the terminal 10 acquires and stores a reference angle Ar (for example, the reference angle A1r), calculates a tilt angle Ac (for example, the tilt angle A1c), and calculates a target value of a control amount. However, instead of these examples, the processor 13 may, for example, detect a tilt angle Ad and determine the presence or absence of a touch by the operator, and transmit, to the vehicle 20, information on the detected tilt angle Ad and the determination result. On the other hand, the processor 25 of the vehicle 20 may acquire the reference angle Ar based on the information from the terminal 10 and store the reference angle Ar in the memory device 26. The processor 25 may also calculate a tilt angle Ac based on the tilt angle Ad transmitted from the terminal 10 and the stored reference angle Ar. The processor 25 may further calculate a target value of a control amount based on the calculated tilt angle Ac.

Alternatively, for example, the processor 13 of the terminal 10 may execute processing up to acquisition and storage of the reference angle Ar, or may execute processing up to calculation of the tilt angle Ac.

What is claimed is:

1. A mobile terminal operated by an operator to remotely support a moving body, the mobile terminal comprising:
a communication device configured to perform wireless communication with the moving body;
a touch panel configured to detect a presence or absence of a touch by the operator; and
a processor, wherein
a motion of the moving body is controlled in accordance with an operation of the operator tilting the mobile terminal while touching the touch panel, and
the processor is configured to:
determine, as a reference angle in a specific rotation direction of the mobile terminal, a tilt angle of the mobile terminal in the specific rotation direction at a time point of detection of a touch by the operator on the touch panel;
generate a control signal for the motion of the moving body based on the reference angle and the tilt angle in the specific rotation direction during a control validity period in which the touch is continued from the time point of the detection; and
transmit the generated control signal to the moving body via the communication device.

2. The mobile terminal according to claim 1, wherein
the processor is configured to reset the reference angle in response to release of the touch by the operator.

3. The mobile terminal according to claim 1, wherein
where a new touch on the touch panel is detected after the touch by the operator is released, the processor updates the reference angle with a tilt angle in the specific rotation direction at a time point of the detection of the new touch.

4. The mobile terminal according to claim 1, wherein
where a difference between a tilt angle in the specific rotation direction and the reference angle is less than a threshold value during the control validity period, the processor generates the control signal such that a control amount of the motion of the moving body does not change.

5. A remote support system including a moving body and a mobile terminal operated by an operator to remotely support the moving body, the remote support system comprising one or more processors, wherein
the mobile terminal includes:
a communication device configured to perform wireless communication with the moving body; and
a touch panel configured to detect a presence or absence of a touch by the operator,
a motion of the moving body is controlled in accordance with an operation of the operator tilting the mobile terminal while touching the touch panel, and
the one or more processors are configured to:
determine, as a reference angle in a specific rotation direction of the mobile terminal, a tilt angle of the mobile terminal in the specific rotation direction at a time point of detection of a touch by the operator on the touch panel; and
generate a control signal for the motion of the moving body based on the reference angle and the tilt angle in the specific rotation direction during a control validity period in which the touch is continued from the time point of the detection.
